(19) United States
(12) Patent Application Publication
(10) Pub. No.: US 2007/0115621 A1
(43) Pub. Date: May 24, 2007

(54) Appearance altering overlay

(76) Inventor: Ruby Guillen, La Palma, CA (US)

Correspondence Address: ADVANTAGE IP LAW FIRM, 3020 OLD RANCH PARKWAY, SUITE 340, SEAL BEACH, CA, 90740, US

(21) Appl. No.: 11/286,964

(22) Filed: Nov. 23, 2005

(51) Int. Cl. G06F 1/16

(52) U.S. Cl. 361/683

(57) ABSTRACT

For customizing the finished exterior appearance of an OEM portable electron device, an appearance altering overlay is provided with a covering body having an interior surface constructed to overlie the finished surface, a customizable exterior surface defining a second appearance, and connectors with respective retention members operable to releasably retain the covering body on the protective housing, during use or transport of the device, and in a non-obstructional manner relative to a display screen of the device while aligning the exterior surface to cover up at least a portion of the finished surface so as present the second appearance to a viewer in place of the first appearance provided by the manufacturer.

### BACKGROUND OF THE INVENTION

1. Field of the Invention

This invention generally relates to accessories for portable electronic devices and more particularly to customizable attachments for use with the housings of portable electronic devices.

2. General Background and State of the Art

A typical portable electronic device such as a laptop computer includes a multi-piece plastic or metallic housing enclosing a primary input section such as a keyboard and a primary output section such as a display screen. Such housing may also enclose slots for a battery pack, optical disc drive, and a range of connector slots. A common construction is the two section clam shell laptop. The lower section or base houses the key board, battery pack, connector slots, and optical disc drive. The upper section encloses the display screen. Both sections are connected via at least one hinge. When closed together, the display screen is protected between the upper and lower sections. The back side of the upper section is typically a plastic or metal rear cover plate that covers up the rear portion of the display screen and protects the screen when the case is closed. A company logo is generally displayed on rear cover plate. Common colors include silver, chrome, grey, black, and white. The rear panel is typically opaque. While a company may put out different product line versions, most of the changes from version to version address the functionality and size of the internal electronic components of the device to produce faster processing speeds, smaller case profiles, and lighter weight components. However, each model is substantially like the others in appearance. While the color of the line may also be periodically modified, the user is still stuck with the device's cosmetic appearance as purchased. In addition, the company logo is typically prominently placed on the rear cover plate.

However, it will be appreciated that with the increased use of laptops, and in particular for presentation purposes, an advertising avenue is not being fully exploited. Often, the presenter will set up the laptop in a visible section of the room and couple the laptop to a projector or other display device. Thus, the back side of the laptop remains in view before the captive audience during the entire presentation. Some simplistic attempts to customize the laptop's appearance have been attempted to take advantage of this space. One example is provided by individuals who generally tape a sheet of paper or place a sticker on the rear cover plate of the laptop bearing their company logo or other related advertising feature. However, the durability of these materials and their less than professional appearance call into question their usefulness.

Another approach is provided in U.S. Pat. No. 6,125,033 and related U.S. Pat. No. 5,870,282, both to Andre' et al. The approach in these patents is to provide a reconfigurable attachment plate for a laptop. A bezel formed on the rear surface of the upper housing of the mobile computer includes a mounting surface for receiving an intermediate attachment plate. The attachment plate and bezel are releasably connected via a complementary set of complex fingers and slots formed in their respective mating surfaces. A panel is then fixedly retained to the attachment plate. To exchange the panel, the entire attachment plate-panel integrated unit must be removed from the bezel. This complex mating pattern of the attachment plate and bezel creates a significant manufacturing cost and limits the attachment plate to be connected to only those rear cover plates with the complemental fasteners. In addition, there is no means of adjusting the width of the attachment plate and thus the attachment plate will only fit on the game sized laptops.

Other attempts at covering devices such as those found in U.S. Patent. No. D469,120; U.S. Patent. No. D389,818; U.S. Patent. No. D373,348; and U.S. Patent. No. D349,893 are generally flexible plastic covers and useful only as dust covers. Those dust covers found in these patents that merely drape over the electronic device and not secured thereto are impractical to use during transport or use of a mobile electronic device such as a laptop as the covers would fall off of the device. Those dust covers found in these patents that include attachment bands are also impractical since the bands would either obscure the viewing screen (U.S. Patent. No. D373,348) or inhibit opening of the device (U.S. Patent. No. D389,818) when installed.

What is needed and heretofore unavailable is an appearance altering overlay providing a variety of end user customizable options with the capability to conform to a variety of mobile electronic device dimensions without inhibiting the use and/or transportation of the device while remaining relatively inexpensive to manufacture.

### SUMMARY OF THE INVENTION

In accordance with a preferred embodiment of the present invention, an appearance altering overlay, for use with a portable electronic device having a display screen arranged in a protective housing having an external finished surface defining a first appearance, is provided with a covering body with a substantially rigid region and an interior surface constructed to overlie the finished surface in a close fitting arrangement and an exterior surface with an outwardly facing display section defining a second appearance. The overlay may further have first and second connectors with respective retention members projecting from the ends of the covering body and operable to releasably retain the covering body on the protective housing. The connectors are constructed to be releasably retained on the protective housing in a non-obstructional position relative to the display screen while aligning the display section of the covering body to cover up at least some of the finished surface so as present the second user customizable appearance instead of the first appearance provided by the manufacturer. The overlay may be mounted on the portable electronic device during use or transport.

In one aspect of the present invention, the display section of the overlay may include at least one pocket with a viewing window for the storage of user selected materials for further customization of the overlay. An optional closure device may be incorporated into the pocket.

Another feature of the present invention is the provision of at least one expandable region either in a retention member or the covering body wherein the overlay may be expanded to accommodate a variety of portable electronic device dimensions.

Other aspects of the present invention will become apparent with further reference to the following drawings and specification.

### BRIEF DESCRIPTION OF THE DRAWINGS

FIG. 1A is an upper left perspective diagram illustrating an exemplary appearance altering overlay in accordance with the present invention prior to installation on a conventional portable electronic device;

FIG. 1B is a similar view as shown in FIG. 1A with the overlay partially mounted on the portable electronic device;

FIG. 1C is a similar view as shown in FIG. 1A with the overlay completely mounted on the portable electronic device;

FIG. 2 is an enlarged scale front end view of the overlay mounted on the portable electronic device as shown in FIG. 1C;

FIG. 3 is a rear perspective view of a conventional portable electronic device in a working position including the overlay of FIG. 1 mounted thereon with an alternative image;

FIG. 4 is a front view, in reduced scale, of the portable electronic device and overlay of FIG. 3;

FIG. 5 is a perspective view of an alternative embodiment of the appearance altering overlay of FIG. 1A depicting the partial insertion of a sheet of advertising material into a slot opening of a pocket of the overlay;

FIG. 6A is a perspective view of an alternative embodiment of the appearance altering overlay of FIG. 5 illustrating the pocket of FIG. 5 with a closure device;

FIG. 6B is a close-up projection view illustrating an exemplary closure device for the pocket in FIG. 6A;

FIG. 6C is a close-up projection view illustrating another exemplary closure for the pocket in FIG. 6A;

FIG. 7 is an upper left perspective view of a third embodiment of an appearance altering overlay in accordance with the present invention wherein the overlay includes a flexible region;

FIG. 8 is an upper left perspective of a fourth embodiment of an appearance altering overlay in accordance with the present invention with the overlay separate from the portable electronic device on the left hand side of the drawing and with the overlay mounted on the portable electronic device on the right hand side of the drawing;

FIG. 9 is top view of an alternative embodiment of the appearance altering overlay in accordance with the present invention;

FIG. 10 is a front view of the conventional portable electronic device with the overlay of FIG. 9 mounted thereon and including alternative fasteners;

FIG. 11 is a top view of another embodiment of the appearance altering overlay in accordance with the present invention with the connectors in an unstretched condition;

FIG. 12 is a bottom end view of the overlay in FIG. 11, the top end view being substantially identical;

FIG. 13 is a top view of an exemplary portable electronic device in a closed configuration with the overlay of FIG. 11 mounted thereon and the connectors in a stretched condition;

FIG. 14 is a bottom end view of the device and overlay of FIG. 13;

FIG. 15 is a top view of an alternative embodiment of appearance altering overlay in accordance with the present invention with the central region of the overlay in an unstretched condition;

FIG. 16 is a bottom end view of the overlay of FIG. 15, the top end view being substantially identical;

FIG. 17 is a top view of an exemplary portable electronic device in a closed configuration with the overlay of FIG. 15 mounted thereon and the central region of the overlay in a stretched condition; and

FIG. 18 is a bottom end view of the overlay and portable electronic device of FIG. 17.

### DETAILED DESCRIPTION OF THE PREFERRED EMBODIMENTS

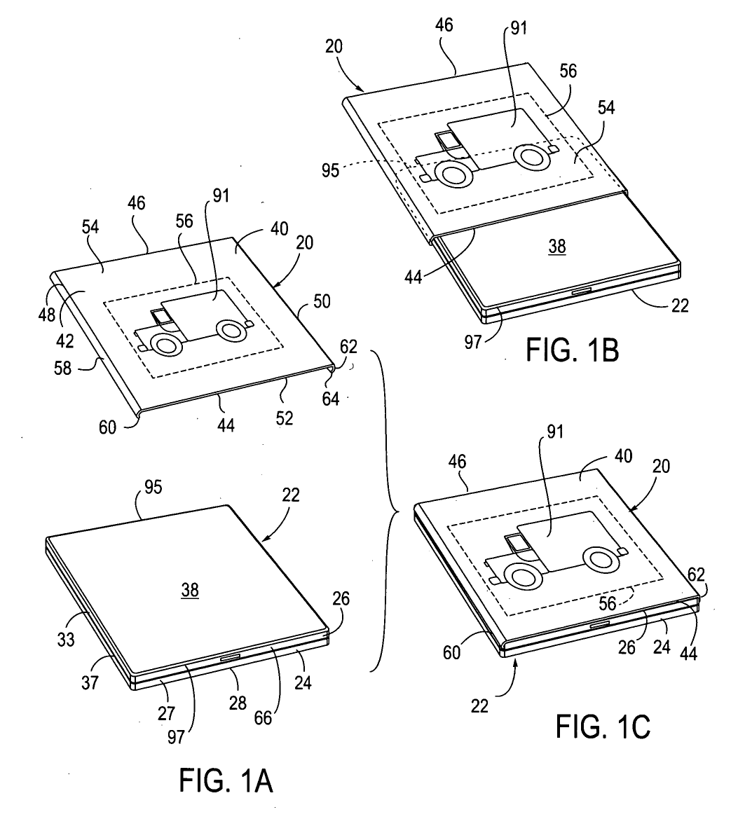

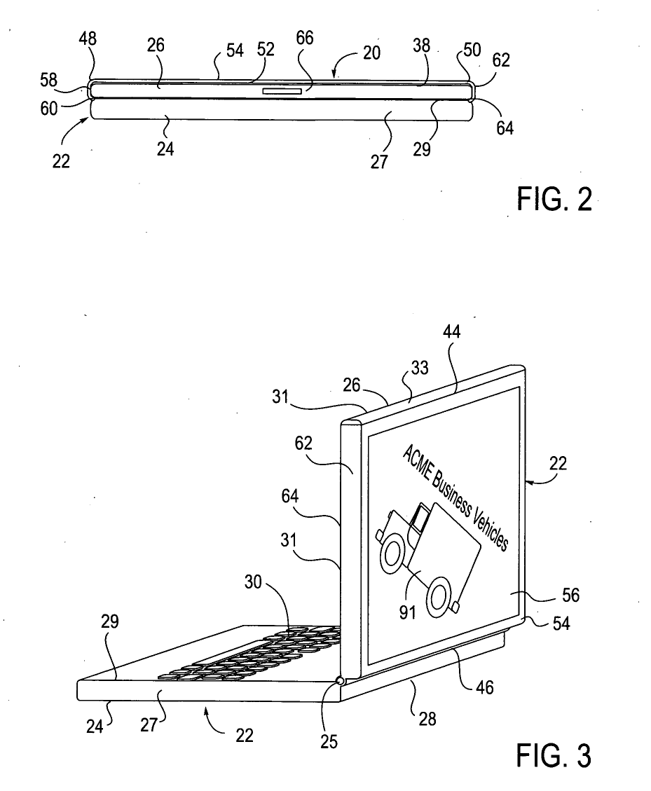

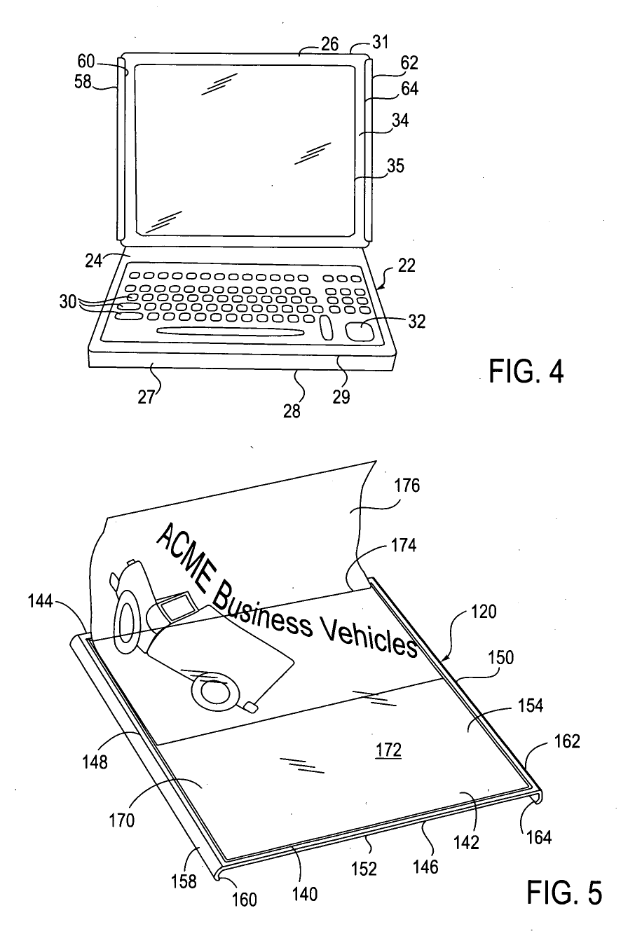

Referring initially to the illustrations in FIGS. 1A-1C, an exemplary appearance altering overlay, in accordance with the present invention and generally designated 20, is depicted in three stages of assembly including complete separation, intermediate installation, and complete installation on a conventional portable electronic device, generally designated 22, such as an original equipment manufacturer (OEM) laptop computer. In FIGS. 1A-1C and 2, the portable electronic device is shown in a closed configuration commonly assumed during transport or storage. In FIGS. 3-4, the portable electronic device is shown in an open configuration commonly assumed during use.

Referring now to FIGS. 1A-4, the conventional portable electronic device 22 is in the form of a rectangular two-piece clam shell construction comprised of a lower housing 24 connected via an elongated back side hinge 25 (FIG. 3) to an upper housing 26. The lower housing 24 provides a flat base 28 for resting the device on a flat surface or on the user's lap. This base is normally hidden from view when the device is in use and typically includes an access door for the battery pack. Projecting upwardly from all four sides of the base is a lower side wall 27 that spans the periphery of the base and terminates in an uppermost edge 29 (FIGS. 3-4).

Arranged centrally in the lower housing 24 is a set of input devices, such as a keyboard 30 and touchpad 32, positioned such that the input surfaces are exposed and facing upwardly when the electronic device is opened up and placed on its base 28 (FIGS. 3-4). The lower housing 24 also encloses and protects several conventional components omitted from the figures including circuit boards, optical and magnetic storage drives, and a power source, i.e. a battery pack. Several openings are located around the peripheral side wall 27 of the lower housing to accommodate interface ports (not shown) providing a means of communication between internal and external components or accessories. The rear hinge 25 of the electronic device is typically a single hinge spanning the entire width of the device and sufficiently resistant to rotation such that the upper housing 26 may be rotated relative to the lower housing through a range of angles of approximately zero to 135 degrees and maintained in a fixed position at any angle in this range.

The upper housing 26 of the portable device 22 is typically rectangular and includes a central recess to receive a display device such as an LCD display or other conventional display device. A border 34 on the forward facing side of the upper housing, as viewed in FIG. 4, spans the periphery 35 of the display device viewing screen 36 and positions the screen centrally within the upper housing. The display screen 36 is arranged to face forwardly when the portable device is in the open position and presented to the user as in FIG. 4. In the closed position, the display screen is protected between the housings 24 and 26 and recessed sufficiently to avoid impact from the raised input surfaces of the input devices 30 and 32.

With continued reference to FIGS. 1A and 1B, the outermost surface 38 of the upper housing 26 is a finished surface that commonly includes the manufacturer's logo (not shown). This finished surface 38 of the upper housing 26 is conventionally constructed of a rigid plastic material and often provided with a protective coating. The finished surface is the normally rearward facing surface of the upper housing, relative to the portable device user, when the portable device 22 is in an open position. The OEM finished surface is thus highly visible from the back side when the portable device 22 is in use and also during transport when the portable device is closed. In either state, the finished surface generally dominates the exterior appearance of the device 22. For example, during an event in which the device 22 is used to control an electronically generated presentation, this rear surface 38 of the upper housing 26 generally faces the audience so the presenter can view the display screen 36. In meetings, personnel seated opposite a user are presented with the rear side finished surface 38 appearance when the device is in use. In almost any event where a captive audience is held and the device 22 is used, the audience will be viewing this finished surface 38 while the user views the display screen 36 and controls the presentation or reads from the display screen.

In addition, when the portable device 22 is closed, the appearance of the finished surface 38 of the upper housing 26 is the predominant visible feature of the portable device 22. While an OEM may provide different product lines of portable devices 22 incorporating different exterior appearances, each model in a line is conventionally manufactured to appear the same. Even between different product lines there are generally consistent features such as the color and placement and style of the company logo. Conventionally, this top surface 38, as viewed when the portable device is closed and placed on a support surface, is quite plain in appearance and common colors are black, gray, and white. This finished surface 38 is generally flat and rectangular but may include contours as well such as around the logo.

The finished surface 38 is connected to the outermost edge of the border 34 by a continuous upper housing sidewall 33. Where the sidewall 33 meets the border 34, an edge is formed 31. When the upper and lower housings 24 and 26, respectively, are closed together, the uppermost edge 29 and lowermost edge 31 of the housings 24 and 26, respectively, meet to create a central seal line 37 around the periphery of the portable device 22. The lower and upper housings 24 and 26 are formed of a rigid plastic that may be coated to resist scratching and scuffing. The housings protect the internal components of the portable device 22. The outer edges of the housings are generally rounded off. The inner edges 29 and 31 typically have a more severe transition, i.e. a relatively more defined or sharper edge, than the outer edges.

Advantageously, the overlay of the present invention provides a means to alter this standardized OEM appearance in an economical manner with the added flexibility of adapting to multiple configurations of portable electronic device housings. Use of the overlay conveniently allows end users to customize their laptops and express themselves without being limited by the OEM designs. In addition, end users may take advantage of the space on the rear of the portable device to advertise their services since this dominant viewing surface will often get significant viewing time before a captive audience.

With continued reference to FIGS. 1A-4, the appearance altering overlay 20 includes a covering body 40 coextensive with a generally rectangular shaped central section 42 bounded by a free front edge 44, a free back edge 46, and left and right edges, 48 and 50, respectively, as viewed in FIG. 1A. In this exemplary embodiment, the opposing sets of edges are parallel to one another. When the overlay 20 is mounted on the portable device 22, the front edge 44 becomes the top edge and the back edge 46 becomes the bottom edge as viewed in FIG. 3 with the portable device in an operating position. The bottom or rear edge is generally defined as the edge that is closest to the hinge 25 when the overlay 20 is mounted on the portable device 22.

The covering body 40 is preferably formed of a relatively thin but rigid plastic material but other suitable materials will occur to one of ordinary skill. The covering body includes an interior surface 52 that is constructed to be placed in close fitting arrangement with the finished surface 38 of the portable device 22. When the overlay 20 is mounted on the portable device 22, the interior surface 52 may directly abut the finished surface or may be closely spaced such that a relatively small gap is present between the two surfaces 38 and 52. Thus, while the interior surface 52 is shown planar in FIGS. 1A and 2 for use with a substantially planar finished surface 38, should the finished surface include contours or other raised or depressed features, the interior surface would preferably be molded or otherwise suitably constructed to accommodate such features or include a sufficient gap to pass over such finished surface features during installation. The interior surface is preferably formed to complement the portion of the finished surface 38 that it covers although this is not a necessity.

On the flip side of the covering body 40 is an outwardly facing surface 54 including a display section 56, outlined in dashed lines, disposed within the exterior surface. The display section may be coextensive with the entire exterior surface of the covering body 40 or merely comprise a portion thereof. This display section is preferably constructed to be an indicia receiving surface wherein a desired design or image 91 may be silk-screened or otherwise suitably imprinted onto or adhered to its surface. In FIG. 3, the design includes both an image and text and is rotated relative to the image in FIG. 1A to present a right side up image when the portable device is opened as in FIG. 3. In addition, the display section may be smooth, raised, and/or textured and generally provides a surface for advertising or customizing the appearance of the portable device 22. The plastic overlay 20 may be dyed or otherwise colored with any color or combination of colors suitable for such process. The covering body 40 may also be transparent, semi-transparent, or opaque.

With reference to FIGS. 1A-1C and 2, projecting downwardly from the left edge 48 of the covering body 40, a generally C-shaped hook 58 forms a first connector. The lower most edge of the hook forms a retention lip 60. In a similar manner, a C-shaped hook 62 projects downwardly from the right edge 50 of the covering body and forms an opposing second connector. The lower most edge of the second hook 62 also terminates in a retention lip 64. The concave curvatures of the C-shaped hooks face one another. The hooks and covering body cooperate to form a generally channel shaped overlay 20. Both connectors span the length of their corresponding left and right edges of the covering body 40. With the overlay 20 mounted on the portable electronic device 22, these hooks 58 and 62 cooperate to resist lateral movement of the overlay in relation to the device 22. As shown in FIG. 2, the retention lips hook under opposing sides of the lowermost edge 31 of the upper housing 26 of the portable device 22 and cooperate to resist upward removal of the overlay 20 in relation to the upper housing 26 when mounted thereon. Both the hooks and covering body of the overlay are preferably manufactured of a rigid plastic and dimensioned for a snug fit with the upper housing 26 of the portable device 22. The hooks 58 and 62 are preferably constructed to be resilient and include a small degree of flex capability so that the hooks 58 and 62 may bend outwardly, if necessary, such that their respective retention lips 60 and 64 may pass over the outside edge 33 of the upper housing and then snap back into place underneath the lowermost edge 31 and squeeze inwardly to resist significant sliding movement of the overlay in relation to the portable device once the overlay is fully mounted thereon. The overlay 20 is frictionally retained to the upper housing 26 of the portable device 22 but can be removed with sufficient effort by the user. Such construction facilitates “snapping” the overlay in place onto the upper housing. Alternatively, the overlay may be slid over the upper housing as viewed progressively in FIGS. 1A-1C and described in further detail below.

For those portable devices 22 incorporating an upper housing 26 slightly larger than the width between the retention lips 60 and 64 of opposing hooks 58 and 62, respectively, the retention lips may actually flex outwardly and dig into opposing regions of the sidewall 33 of the upper housing 26. A similar situation may occur if the distance between the corresponding covering body edge 48, 50 and retention lip 60, 64 is less than the height of the upper housing sidewall 33. Given that most OEMs construct their portable electronic devices in a single product line with identical dimensions, it will be appreciated that the overlay 20 may be constructed to closely fit over such known dimensions to maximize the closeness of fit between the overlay and the upper housing. In addition, the flex capability of the hooks enables the overlay to fit on a variety of dimensions. As discussed below, other embodiments of the present invention provide even more flexibility in this regard.

In operation, referring to FIGS. 1A-4, the user selects the desired overlay 20 with the desired color, pattern, or design 91 for placement on a portable electronic device 22 to change its outward appearance. The portable device may be placed in the open or closed configuration. With both hands, the user grasps the overlay 20 with the exterior surface facing upwards and then aligns the left and right hooks 58, 62 with the corresponding left and right sides of the upper housing 26 of the portable device 22 (FIGS. 1A-2). The user then slides the overlay onto the upper housing with the retention lips 60, 64 curling under and sliding along opposing regions of the lowermost edge 31 of the upper housing 26. This is continued until the rear edge 46 of the overlay is generally aligned with the back edge 95 of the upper housing 26 (FIGS. 1A-4). In this position, the top edge 44 of the overlay 20 is aligned with the front edge 97 of the upper housing and the interior surface 52 of the overlay is in close proximity with or abutting the finished surface 38.

With the overlay 20 fully mounted on the upper housing 26 of the portable device 22 (FIGS. 1C and 4) the appearance of the finished surface 38 is hidden from view and replaced with the exterior surface 54 and display section 56 of the overlay to present an alternative appearance dictated by the choice of the user. It will also be appreciated that, as shown in FIG. 4, the hooks 60 and 64 are located outside the peripheral edge 35 of the display screen 36 and do not obstruct the viewing screen 36 in any manner. In addition, the portable electronic device may be closed in the normal manner (FIGS. 1C and 2). It will be appreciated that the overlay is generally reversible so that the image may be selectively positioned by the user depending on the anticipated audience viewing position as indicated by the alternate positions of the exemplary images 91 shown in FIGS. 1C and 3.

While mounted on the upper housing 26, the overlay 20 resists removal due to the frictional resistance between the hooks 58 and 62 and the peripheral sidewall 33 and lowermost edge 31 of the upper housing. However, removal of the overlay may be accomplished by grasping the overlay with a couple of fingers on at least one hand to draw the overlay toward the user as the thumb of that hand in use pushes the front region 66 of the upper housing sidewall 33 (FIG. 1A). Alternatively, the reversible overlay may also be slid off the back of the upper housing as in FIG. 1B. Once the overlay is withdrawn a few inches from the upper housing, as shown, for example, in FIG. 1B as partially withdrawn from the rear edge 95 of the upper housing, the leading edge, in this illustration rear edge 46, may be grasped by one of the user's hands and drawn completely away from the upper housing 26 while the user's other hand presses against the closest sidewall region of the upper housing and holds the portable device 22 in place. Given the ease of exchanging overlays, it will be appreciated that a user could purchase a number of different overlays 20 and swap them out quite easily thus customizing the portable device with a countless number of expressions.

With the aforementioned principles of the present invention in mind, FIG. 5 illustrates another embodiment of the present invention wherein like components are numbered alike. This alternative appearance altering overlay, generally designated 120, includes a covering body 140 and central section 142 with a free front edge 144, free back edge 146, and left and right edges 148 and 150, respectively. The covering body in this overlay is modified to include a pocket 170 with a transparent viewing window 172 and an opening along the top edge 174 of the pocket to provide additional customization options. The pocket is constructed to receive substantially flattened articles such as the exemplary photograph designated 176, shown partially inserted into the pocket 170 in FIG. 5. The photo may be viewed through the viewing window 172 when placed inside the pocket. Other suitable flattened articles will occur to one of ordinary skill and may be inserted into the pocket. In addition, the pocket may include a conventional expanded region or folded accordion sides (not shown) to accommodate thicker articles. This overlay 120 includes connectors 158 and 162 constructed in a similar fashion as the connectors 58 and 62 of the previous overlay 20 and may be mounted on and removed from the portable electronic device 22 in the same manner.

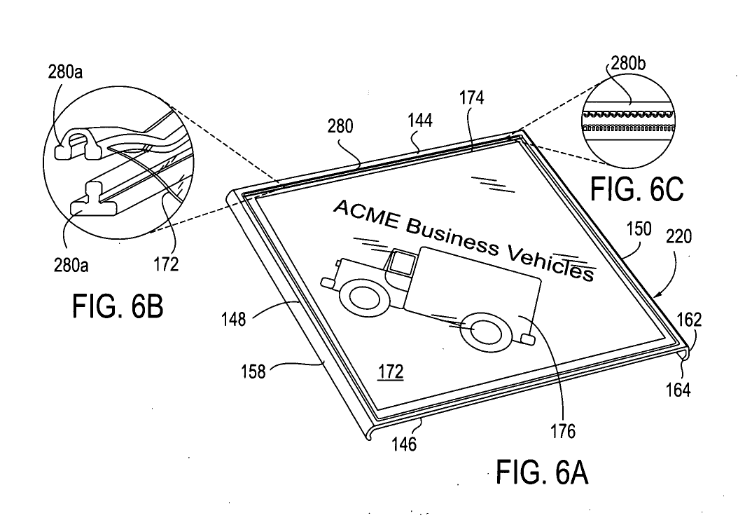

In the exemplary overlay 120 illustrated in FIG. 5, the pocket 170 does not include a closure device. However, as illustrated in FIGS. 6A-6C, wherein like components are numbered alike, the top edge of the pocket 174 has been modified to include a closure device 280 as illustrated in the exemplary embodiment of the overlay generally designated 220. Exemplary closure devices 280 in the form of a tongue and groove closure 280a (FIG. 6B) or a hook and loop type fastener 280b (FIG. 6C), may be used to prevent inadvertent removal of the inserted article 176. Other suitable closure devices will occur to one of ordinary skill.

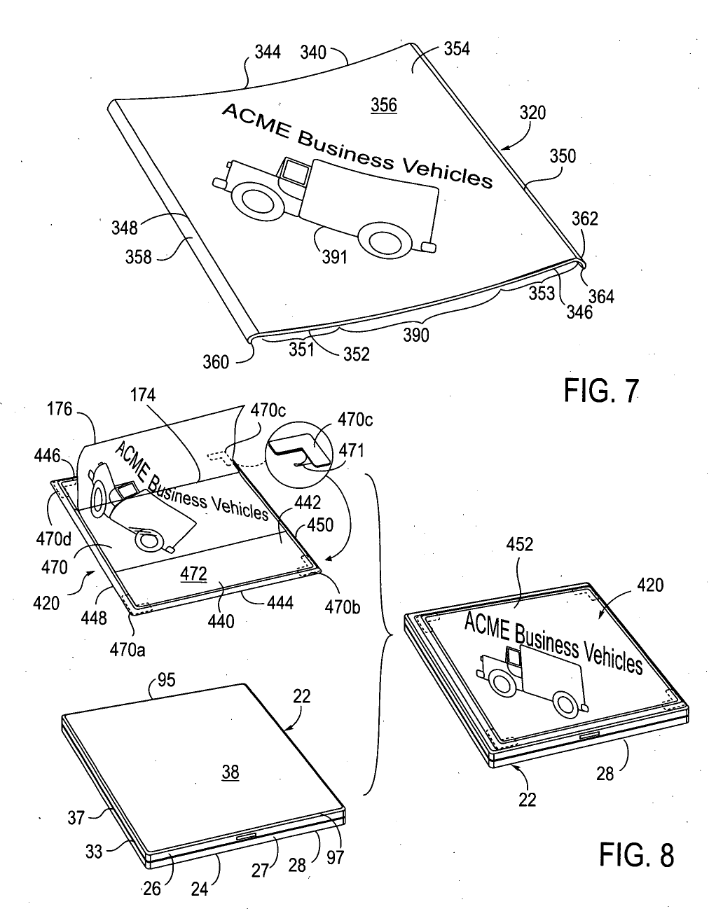

While the covering body of the overlay has been described in previous examples as a substantially rigid plate, the covering body may also include a flexible region 390 such as that illustrated in the exemplary embodiment generally designated 320 shown in FIG. 7. The flexible region 390 comprises approximately half the width of the covering body 340 and is positioned about an intermediate point of the covering body and further extends from the front edge 344 to the rear edge 346 of the covering body. To either side of the flexible region 390, left and right outer regions designated 351 and 353, respectively, are rigid. These outer regions span generally from the outer edges of the flexible region 390 to the outer edges 348 and 350 of the covering body 340. The flexibility of the flexible region 390 extends from the exterior surface 354 to the interior surface 352 of the covering body 340. The display section 356 may encompass both flexible and rigid regions so that the image 391 may appear in both regions. The connectors 358 and 362 are constructed as described for the previous overlay 20 connectors 58 and 62. With such centralized flexibility, the user may align the overlay 320 on top of the upper housing 26 of the portable electronic device 22 with the interior surface opposite the finished surface 38 of the device 22. The user may then simply press the overlay 320 downwardly onto the upper housing 26 to flex the middle flexible region 390 of the overlay and drive the retention lips 360, 364 of the hooks 358, 362, respectively, outwardly and over the sidewall 33 of the upper housing. The resilient retention lips of the hooks will snap back into place once the lowermost edge 31 of the upper housing is cleared. The overlay may be removed as described with the first embodiment.

A rapid slap-on appearance altering overlay 420 is illustrated in FIG. 8. This overlay includes a central section 440 with a display section 442 as modified with a pocket 470 and viewing window 472 along the lines of those discussed in connection with FIGS. 5 and 6A-6C above. Instead of hooks, releasable adhesive strips 470a, 470b, 470c, 470d are disposed in each of the four corners of the covering body on the interior surface 452. Each adhesive includes removable protective paper 471 that is removed before use. The user may peel off the protective paper of each adhesive strip 470a-d and place the overlay 420 on the finished surface 38 of the portable device to cover the finished surface 38 by aligning the front edge 444 with the leading edge 97 of the finished surface 38 and the rear edge 446 with the trailing or bottom edge 95 of the finished surface resulting in an overlay 420 covering the finished surface 38 of the portable electronic device 22 as shown on the right hand side of FIG. 8. A selected article 176 may be inserted through the pocket opening 174 into the pocket and may be viewed through the pocket viewing window 172 thereby substituting the finished OEM appearance of the upper housing with the appearance selected by the user and positioned in the pocket. The overlay 420 may be removed by peeling it off the finished surface 38.

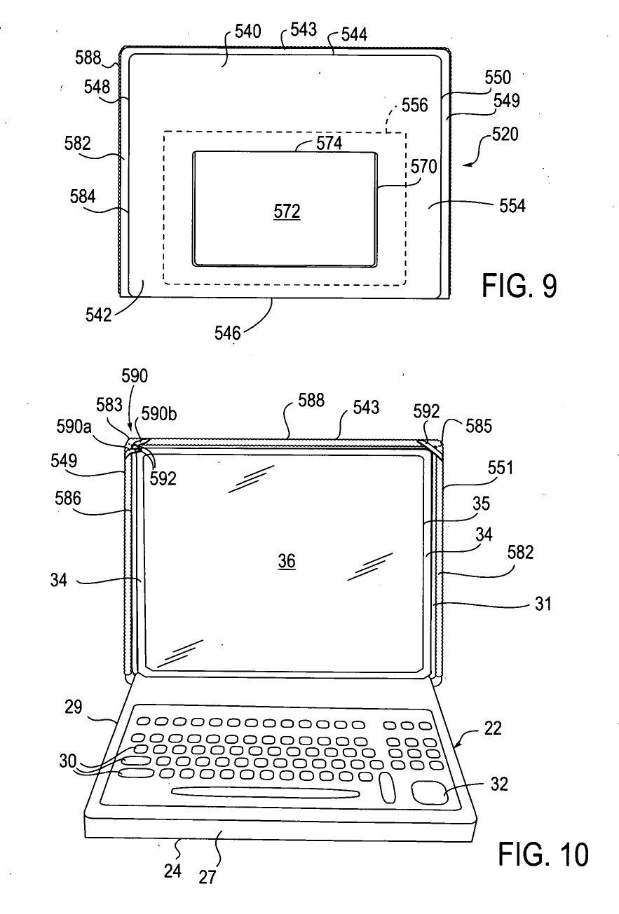

As ownership of multiple laptops or upgrading to a new model with different dimensions is a common occurrence, the user may desire to purchase an appearance altering overlay with even more flexible adjustable width features as will now be discussed in reference to FIGS. 9-18.

With specific reference to FIGS. 9-10, another exemplary embodiment of an appearance altering overlay, according to the present invention and generally designated 520, is illustrated. The overlay includes a generally planar covering body 540 with a coextensive central section 542 defining an exterior surface 554 including a display section 556 designated in dashed lines. The covering body includes a front edge 544, a free back edge 546, a left side edge 548, and a right side edge 550. The covering body 540 of this embodiment includes an interior surface (not shown) constructed similarly to earlier described embodiments for a close fitting arrangement with the finished surface 38 (FIG. 1A) of the portable electronic device 22. Within the display section 556, a pocket 570 with a viewing window 572 is provided to hold articles to further customize the appearance of the overlay 520. Secured to the top edge 544 and left and right side edges 548, 550 of the covering body using conventional fabric to plastic adherence methods is an expandable skirt 582 constructed of a suitable fabric material. The skirt is approximately ½ to ¾ of an inch high from the secured edge 584 to the free edge 586. The skirt includes a peripheral elastic region 588 so that the skirt may be stretched over the upper panel 26 of the laptop. As the lowermost peripheral edge 546 of the covering body does not include a skirt portion, the edge of the overlay 520 will not interfere with opening or closing the upper housing 26 by bunching up near the portable device hinge 25.

As shown in FIG. 10, two versions of optional left and right retention bands 590 and 592, respectively, may be sewn into the free edges of the skirt 582 near the upper corners 583, 585 as viewed in FIG. 10. The left side retention band 590 as viewed in FIG. 10 is a two-piece component with a first strap 590a fixed to the edge 549 of the skirt running parallel to the right edge 550 of the covering body 540. A second strap 590b is fixed to the edge of the skirt 543 running parallel to the top edge 544 of the covering body 540. The free ends of the straps include complementary fasteners 592 such as the hook and loop variety, snaps, buttons, or other suitable fastening device to fastener the straps 590a, 590b together. Alternatively, a single component band such as the right hand retention band 592 may be fixed to the free edges 543 and 551 of the skirt 582 across a corner 585. The retention bands are preferably elastic. It is preferred that the covering body 540 and skirt 582 are sized at least slightly smaller in width and height in an unstretched state than the known dimensions of an OEM upper housing 26 of the portable device 22 so as to ensure a snug fit when the skirt 582 is stretched over the upper housing. The retention bands 590, 592 may be used to further inhibit the cover from being removed inadvertently but are an optional feature. It is preferred that the skirt 582 and bands 590, 592 do not obscure the display screen 36 and are secured external to the peripheral edge 35 of the display screen while the device is open and in use as shown in FIG. 10. In addition, the skirt is preferably dimensioned so as not to inhibit the closing of the device 22.

In use, with exterior surface 554 facing outwards, the user may slip the overlay 520 over the upper housing 26 until the bottom edge 546 approximately aligns with the hinge 25 of the device 22. The elastic skirt 588 may be stretched during the procedure to accommodate a larger housing dimension. The skirt may then be adjusted to center the covering body 540 on the finished surface 38 of the upper housing thus covering up the finished surface and substituting a new user defined customized appearance. The lower peripheral edge of the skirt will constrict and wrap around the lowermost edge 31 of the upper housing so as to resist removal of the overlay from the upper housing but without obstructing the display screen 36. The user may also open the pocket 570 and insert the desired article for viewing through the viewing window 572. It will be appreciated that a two-sided skirt with elastic regions on the left and right sides of the covering body would also be suitable.

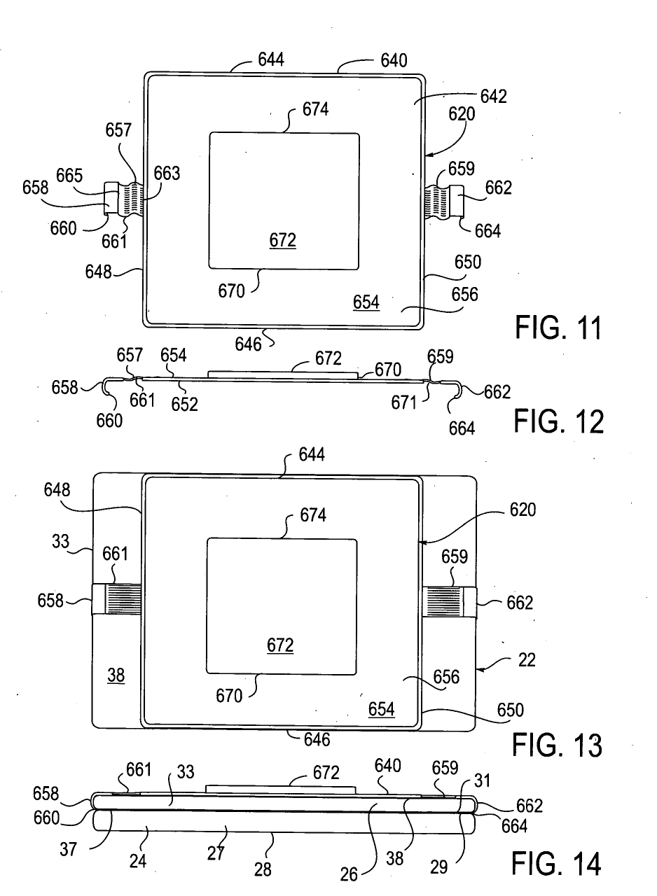

Turning now to FIGS. 11-14, yet another embodiment of an appearance altering overlay, in accordance with the present invention and generally designated 620, is illustrated wherein like components are numbered alike. The overlay includes a rectangular covering body 640 having a central section 642 bounded by an upper free edge 644, a lower free edge 646, a left side edge 648, and a right side edge 650. The covering body includes an interior surface 652 constructed to fit closely over at least a portion of the finished surface 38 of the upper housing 26 of the device 22. In this exemplary embodiment, the covering body is approximately two-thirds the width of the finished surface 38. On the opposite side of the covering body is an exterior surface 654 with a central display section 656. In this exemplary embodiment, the display section is coextensive with the exterior surface of the covering body. A pocket 670 for receiving user selected materials that can be presented through a viewing window 672 is adhered to the exterior surface 654 within the display section 656 thereby adding another customizing option for the user. A user may insert a substantially flattened article through the top opening 674 of the pocket where the article may be viewed through the viewing window. Other suitable shapes for the covering body will occur to one of ordinary skill and the exemplary rectangular shape is not meant to be limiting.

On the opposing left and right hand sides 648 and 650, respectively, as viewed in FIG. 11, is a left connector 657 and a right connector 659. The left connector 657 includes an elastic extension band 661 with one end 663 connected to a portion of the left edge 648 of the covering body 640 at an intermediate position and a second distal end 665 connected to a C-shaped hook 658 terminating in a retention lip 660. The hook may be made of plastic and covered with a rubber material to grip the plastic edges of the upper housing 26 in an improved manner. The right connector 659 is constructed identically to the left connector and also includes an elastic extension band 671 terminating in a hook 662 with a retention lip 664. The right connector is attached to and projects from the right edge 650 of the covering body such that the connectors project from the covering body in opposite directions.

In use, with FIGS. 11-12 representing the overlay 620 in an unstretched state and FIGS. 13-14 representing the overlay in a stretched state, the covering body 640 is placed over the outer surface 38 of the upper housing 26 of the portable electronic device 22 in a closed configuration. The hook 660 from the left connector 657, for example, is then positioned over the left hand edge of the upper housing and with the retention lip 660 contacting the undersurface of the border 34 around the display screen 36 and against the lowermost edge 31 of the upper housing so that it will resist movement to the right as pictured in FIG. 14. The user may then grasp the hook 662 of the right connector 659 and stretch the extension band 671 of the right connector until the retention lip 664 of the hook 662 is disposed beyond the right hand edge of the upper housing 26 as viewed in FIG. 13. The hook is then lowered onto the upper housing and the retention lip 664 is placed in contact with the border 34 around the display screen 36. The hook 662 is then released so that the retention lip engages the undersurface 34 of the upper housing and against the lowermost edge 31 of the upper housing as shown in FIG. 14. In this position, the hooks releasably engage opposing sides of the upper housing. It will be appreciated that the retention lip of either hook may contact the sidewall 33 of the upper housing if the thickness of the upper housing is greater than the height of the hook. With the hooks set, the covering body 640 should be substantially centered on the finished surface 38 with the exterior surface 654 facing outwards (FIGS. 13-14). In this exemplary embodiment, the covering body 640 only covers a substantial portion of the finished surface 38 but still alters the overall appearance provided by the finished surface 38 of the portable electronic device 22.

To remove the exchangeable laptop cover 620 from the portable device 22 in a closed configuration, the user may grasp or pinch the free edges of the hook 662 of the right connector 659 and pull outwardly until the hook clears the outer edge of the sidewall 33 of the upper housing 26. The right connector may then be lifted up and toward the center of the finished surface. The entire covering body 640 may then be removed by sliding the entire appearance altering overlay 620 to the left so as to remove the left hook 658. It will be appreciated the more than one hook per side may be used or the hook may run the entire length of the respective edge of the covering body 640 where it is attached. The connectors may also project from the covering body in other than an orthogonal angle such as in an “X” or “Y” pattern for example.

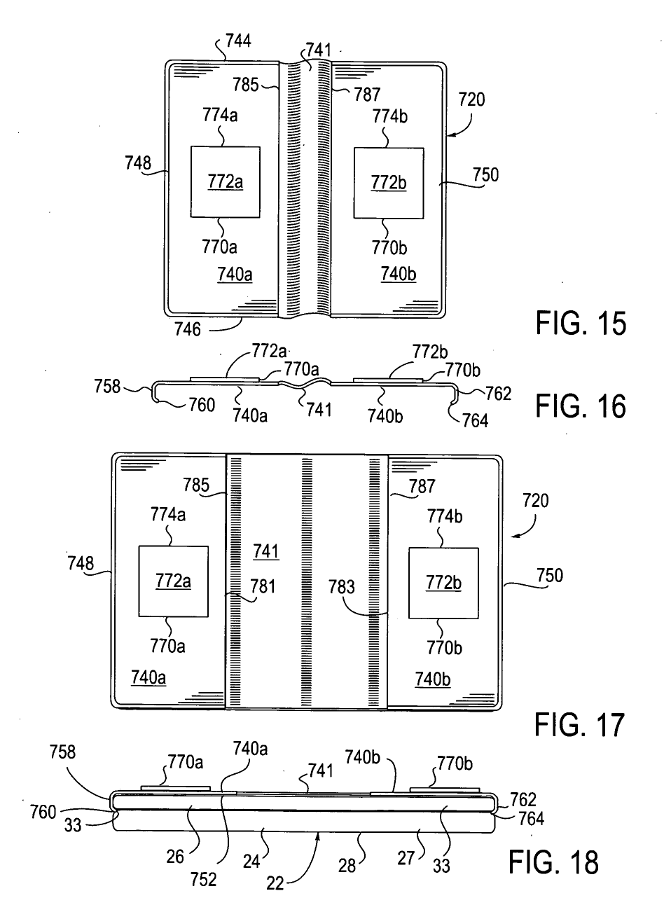

In a variation of the prior embodiments, another embodiment is illustrated in FIGS. 15-18. This appearance altering overlay, generally designated 720, includes a covering body 740 divided into a left plate 740a, a right plate 740b, and an intermediate elastic region 741 connecting the two plates together. The plate include commonly aligned free front edge 744, a free back edge 746, and each plate includes an external outside edge 748 (left hand edge) and 750 (right hand edge). The side edges 748, 750 of each plate 740a, 740b are constructed with C-shaped left and right side connectors 758 and 762, respectively, forming hooks that terminate in retention lips 760 and 764, respectively, as in the overlay embodiment generally designated 20 (FIG. 1) discussed above. However, the covering body 740 of this embodiment includes an intermediate elastic region 741 allowing the covering body to expand to cover a variety of upper housing widths. The elastic region has left and right outer edges 781 and 783, respectively, secured to the respective inner edges 785 and 787 of the left and right plates 740a and 740b using conventional fabric to plastic fastening methods. The center section 741 is preferably constructed of an elastic fabric. Each side plate 740a, 740b, includes a pocket 770a, 770b, respectively, with its own viewing window 772a, 772b for displaying articles inserted through a top opening 774a, 774b, respectively, therein.

This overlay 720 may be installed or uninstalled in the same manner as with the previous embodiments 20 and 620 depending on the width of the upper housing 26. If the overlay 620 does not need to be stretched, then it may be slid over the upper housing and engaged with the lowermost edge 31 as with the overlay 20 described above. If the overlay 720 is smaller in width than the upper housing, then it may be mounted as described in conjunction with the previous overlay 620 resulting in a stretched central section 741. FIGS. 15-16 illustrated the overlay 720 in an unstretched state and FIGS. 17-18 represent the overlay in a stretched state and mounted on the upper housing 26 of a portable electronic device 22. It will be appreciated that more than one elastic region may be used within the confines of the covering body. For example, the covering may be variegated or striped with multiple elastic bands separating rigid sections. In addition, the logo or image may be imprinted on both the rigid and elastic sections so that the display section may encompass both rigid and elastic regions. The logo or image may not be visible until the covering body is stretched out and secured to the laptop cover as shown in FIG. 17.

In the above-described exemplary embodiments, it will be appreciated that the connectors may be constructed to align the centerlines of the covering body with the centerlines of the finished surface or may be constructed to shift the centerlines of the covering body in relation to the centerlines of the finished surface so as to cover an off-center region of the finished surface. It will further be appreciated that the covering body may be constructed with other suitable shapes and is not meant to be limited by the shape of the finished surface.

In the preceding detailed description, the invention is described with reference to specific exemplary embodiments thereof. It will, however, be evident that various modifications and changes may be made thereto without departing from the broader spirit and scope of the invention as set forth in the claims. The specification and drawings are, accordingly, to be regarded in an illustrative rather than a restrictive sense.

What is claimed is:

1. An appearance altering overlay for a portable electronic device having a display screen arranged in a protective housing with an outwardly facing finished surface defining a first appearance, said overlay comprising:
a covering body having at least one region of substantial rigidity and an interior surface constructed to overlie at least a substantial portion of said finished surface in a close fitting arrangement and an exterior surface including an outwardly facing display section defining a second appearance;
a first connector projecting from a first end of said covering body and including a first retention member operable to releasably retain said first end of said covering body on a first extremity of said protective housing; and
a second connector projecting from a second end of said covering body and including a second retention member operable to releasably retain said second end of said covering body on a second extremity of said protective housing, said connectors being constructed to be releasably retained on said protective housing in a non-obstructional position relative to said display screen and to align said display section of said covering body to cover up at least a substantial portion of said first appearance with said second appearance and position said interior surface of said covering body in a close fitting arrangement with said finished surface during use or transport of said portable electronic device.

2. The overlay as set forth in claim 1 wherein:
said display section includes at least one pocket mounted thereon with an opening operable to receive substantially flattened articles.

3. The overlay as set forth in claim 1 wherein:
said covering body and retention members cooperate to form a generally channel shaped overlay with said first and second retention members including hooks operable to engage the opposing outer edges of the protective housing.

4. The overlay as set forth in claim 1 wherein:
said covering body further includes a region of substantial flexibility.

5. The overlay as set forth in claim 1 wherein:
said region of substantial rigidity is formed of a hard plastic material.

6. The overlay as set forth in claim 1 wherein:
said retention members include a flexible, expandable skirt with an elastic band disposed along a free edge of said skirt.

7. The overlay as set forth in claim 6 further including:
at least one retention band connected from one side of said elastic skirt to another.

8. The overlay as set forth in claim 1 wherein:
said display section includes a rigid section and an expandable section.

9. The overlay as set forth in claim 1 wherein:
said first and second retention members include an expandable section terminating in a hook.

10. The overlay as set forth in claim 1 wherein:
said covering body includes at least one expandable region operable to elongate the width of said covering body when stretched.

11. The overlay as set forth in claim 1 wherein:
said display section is transparent.

12. The overlay as set forth in claim 1 wherein:
said display section is smaller in width than a width of said finished surface of said portable electronic device.

13. The overlay as set forth in claim 2 wherein:
said pocket includes a viewing window operable to display the contents of said pocket.

14. The overlay as set forth in claim 1 wherein:
said first and second retention members include a releasable adhesive.

15. The overlay as set forth in claim 2 wherein:
said opening of said at least one pocket includes a fastener operable to close off said pocket opening.

16. The overlay as set forth in claim 1 wherein:
said retention members are operable to substantially align a centerpoint of said covering body with a centerpoint of said protective housing.

17. The overlay as set forth in claim 1 wherein:
said covering body includes a flexible section and said retention members are resilient and operable to snap over and lock onto opposing edges of said protective housing.

18. The overlay as set forth in claim 1 wherein:
said covering body and retention members are a one-piece integral unit.

19. An appearance altering overlay for a laptop having a display screen arranged in a protective housing including an outwardly facing finished surface defining a first appearance, said overlay comprising:
a substantially flattened covering member including a central rigid plastic region with an outwardly facing display section defining a second appearance and an interior covering surface, said covering member including a top edge and a bottom edge, and a first side edge and a second side edge;
a first hook member projecting away from said first side edge toward said interior covering surface;
an opposing hook member projecting away from said second side edge toward said interior covering surface;
a pocket mounted on said display section; and
an expandable section in one of said members and operable, upon application of a pulling force to expand and increase the width of said overlay and wherein said hook members may be releasably engaged with opposing edges of said protective housing during use or transport of said portable electronic device.

20. An appearance altering overlay for a laptop having a display screen arranged in a protective housing including an outwardly facing finished surface defining a first appearance, said overlay comprising:
a channel shaped covering body including a center section with an outwardly facing display surface defining a second appearance and an inwardly facing covering surface;
a first retention member projecting from one side of said body; and
a second retention member projecting from another side of said body, at least one of said retention members being expandable wherein an overall width of said overlay may be increased, said retention members being constructed to releasably retain said covering body with said inwardly facing covering surface abutting said finished surface of said protective housing and said outwardly facing display surface in a position to be viewed when said covering body is on said protective housing.
